(19) United States
(12) Patent Application Publication
(10) Pub. No.: US 2005/0274466 A1
(43) Pub. Date: Dec. 15, 2005

(54) Blind slat structure

(75) Inventor: Ben Hsu, Changhua Hsien (TW)

Correspondence Address: TROXELL LAW OFFICE PLLC;SUITE 1404, 5205 LEESBURG PIKE, FALLS CHURCH, VA, 22041, US

(73) Assignee: Ching Feng Blinds Ind. Co., Ltd.

(21) Appl. No.: 10/912,145

(22) Filed: Aug. 6, 2004

(30) Foreign Application Priority Data
Jun. 1, 2004 (CN) 093208654

(51) Int. Cl. E06B 9/30

(52) U.S. Cl. 160/168.1 R

(57) ABSTRACT

A blind slat structure includes a Venetian blind having rope ladders mounted between an upper and lower beams for a plurality of slats to be sequentially led there-through and equidistantly abutted against for location thereby wherein the upper ends of the rope ladders are wound and located at mounting seats adapted at both inner lateral sides of the upper beam to control the rotation of the slats in different angles thereby, and a guide cord, fixed inside the upper beam at preset position relative to the mounting seats thereof, is extended downwards by the ends to sequentially pass through cord-passages holes disposed at the left/right sides of each slat thereof till both ends thereof coming out through the lower beam and stretched inwards to the middle section at the bottom side of the lower beam to be collected together by a retaining body with a pulling section suspending downwards for a certain length there-from. In operation, the slats of the Venetian blind thereof is simply collected or unfolded via the retaining body that, directly abutted against the lower beam, is easily slid upwards or downwards along the guide cord thereof with the lower beam synchronically moved up or down therewith, achieving an easier and effortless operation thereof so as to avoid the uncomfortable feeling of abrasion to hands caused by a conventional Venetian blind, and efficiently protecting the hands of a user as well as facilitating a smoother and easer operation thereof.

### BACKGROUND OF THE INVENTION

The present invention is related to a blind slat structure, including a Venetian blind made up of rope ladders mounted between an upper and lower beams for a plurality of slats to be equidistantly abutted against for location thereby wherein a guide cord fixed inside the upper beam is extended downwards by the ends to sequentially pass through cord-passages holes disposed at the left/right sides of each slat thereof till both ends thereof coming out through the lower beam and stretched correspondingly inwards to the middle section at the bottom side of the lower beam to be collected together by a retaining body with a pulling section suspending downwards for a certain length there-from. In operation, the slats of the Venetian blind thereof are simply collected or unfolded via the retaining body that, directly abutted against the lower beam, is easily slid upwards or downwards along the guide cord with the lower beam synchronically moved up or down therewith, achieving an easy and effortless operation thereof so as to avoid the uncomfortable feeling of abrasion to hands caused by a conventional Venetian blind, and efficiently protecting the hands of a user as well as facilitating a smoother and easer operation thereof.

Please refer to FIG. 1. A conventional blind slat structure is made up of a Venetian blind 10 having rope ladders 13 mounted between an upper and lower beams 11, 12 for a plurality of slats 14 to be equidistantly abutted against in location thereby, and a pull cord 15 sequentially led through cord-passage holes 141 disposed at the left and right sides of the slats 14 thereon. The upper ends of the pull cord 15 are wound through a pulley seat 111 mounted at one inner side of the upper beam 11 and extending downwards for a certain length there-from to control the folding or unfolding operation of the slats 14 thereby. And the upper ends of the rope ladders 13 are retained by adjustment rollers 161 of mounting seats 16 adapted at both inner lateral sides of the upper beam 11 therein to control the rotation of the slats 14 in different angles.

There are some drawbacks to such conventional blind slat structure. First, the pull cord 15 along with the rope ladders 13 are simultaneously wound through the lower beam 12. When the Venetian blind 10 is collected in operation, great effort is thus required to draw downwards the pull cord 15 carrying the total weight of the lower beam 12 thereof. In case the pull cord 15 gets loose carelessly in the folding-up operation thereof, the weight of the lower beam 12 will quickly draw downwards the pull cord 15 and hands of a users can easily get hurt due to the abrasion against the pull cords 15 thereof, which is quite inconvenient in practical use. Second, the upper ends of the pull cord 15 are wound through the inner side of the upper beam 11 and then the pulley seat 111 in clamping location thereby. Thus, to collect or unfolded the Venetian blind 10, the pull cord 15 must be persistently tilted into an angle and pulled sideways to detach from the clamping location of the pulley seat 111 for smooth operation thereof. When improperly tilted in angle or drawn to the wrong side, the pull cord 15 tends to get jammed or blocked by the pulley seat 111 on and off, which can result in an awkward operation thereof. Third, the pull cord 15 is complicatedly wound through the pulley seat 111 in clamping location thereby, and an assembly hole must be disposed at one lateral side of the upper beam 11 for the pulley seat 111 to be mounted to the upper beam 11 thereby, which not only destroy the overall appearance of the upper beam 11, but also increase the cost of materials thereof.

### SUMMARY OF THE PRESENT INVENTION

It is, therefore, the primary purpose of the present invention to provide a blind slat structure, including a Venetian blind having rope ladders mounted between an upper and lower beams for a plurality of slats to be equidistantly abutted against for location thereby wherein a guide cord fixed inside the upper beam is extended downwards by the ends to sequentially pass through cord-passages holes disposed at the left/right sides of each slat thereof till both ends thereof coming out through the lower beam and stretched correspondingly inwards to the middle section at the bottom side of the lower beam to be collected together by a retaining body with a pulling section suspending downwards for a certain length there-from; thus, in operation, the slats of the Venetian blind thereof are simply collected or unfolded via the retaining body directly abutted against the lower beam to lift upwards or descend the lower beam along the guide cord, achieving an easer and effortless operation thereof.

It is, therefore, the second purpose of the present invention to provide a blind slat structure wherein, via the mutual guide sliding and clamping structure of the guide cord and the retaining body thereof, the retaining body is simply pushed upwards or slide downwards along the guide cord to synchronically move up or down the lower beam therewith in the folding or unfolding operation thereof so as to avoid the uncomfortable feeling of abrasion caused by the above conventional Venetian blind thereof, efficiently protecting the hands of a user as well as facilitating a smoother and easer operation thereof.

It is, therefore, the third purpose of the present invention to provide a blind slat structure wherein the guide cord directly extending downwards from the bottom side of the upper beam is sequentially led through the cord-passage holes of the slats and the lower beam thereof respectively before clamped tight by the retaining body for location thereby, economically omitting the pull cord winding through the inner side of an upper beam and a pulley seat of the above conventional Venetian blind so as to reduce the cost of materials as well as maintain a smooth and neat appearance of the upper beam thereof.

### BRIEF DESCRIPTION OF THE DRAWINGS

FIG. 1 is a perspective view of a conventional blind slat structure.

FIG. 2 is a perspective view of the present invention.

FIG. 3 is a diagram showing the present invention in collecting-up operation thereof FIG. 4 is a diagram showing the present invention in partially gathered-up status.

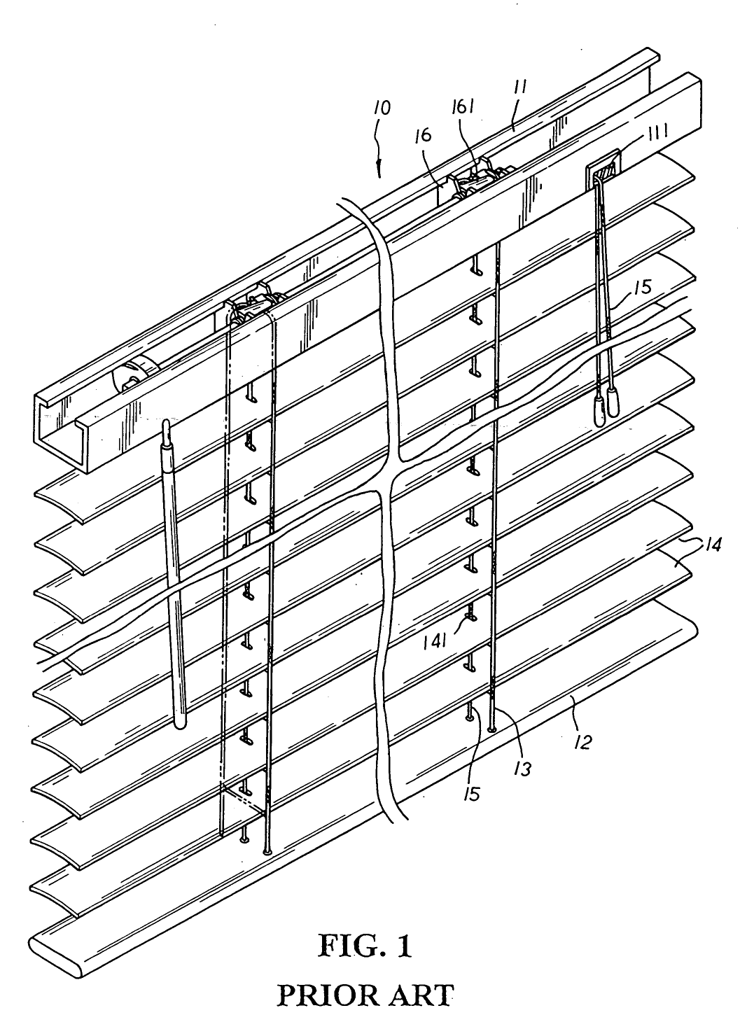

### DETAILED DESCRIPTION OF THE PREFERRED EMBODIMENTS

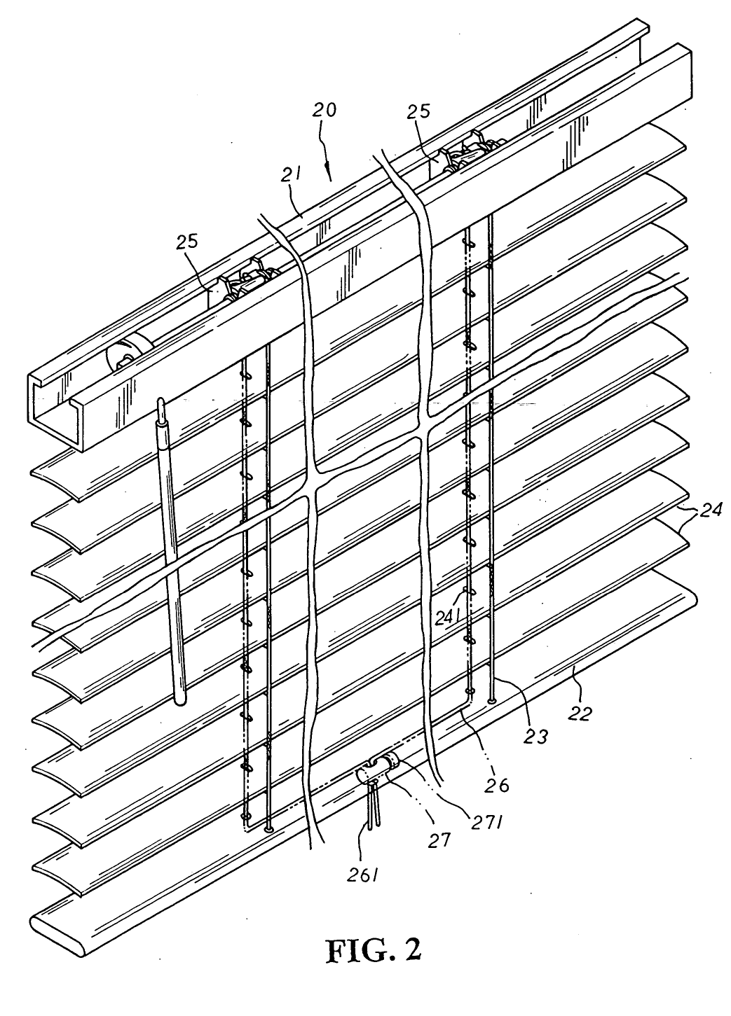

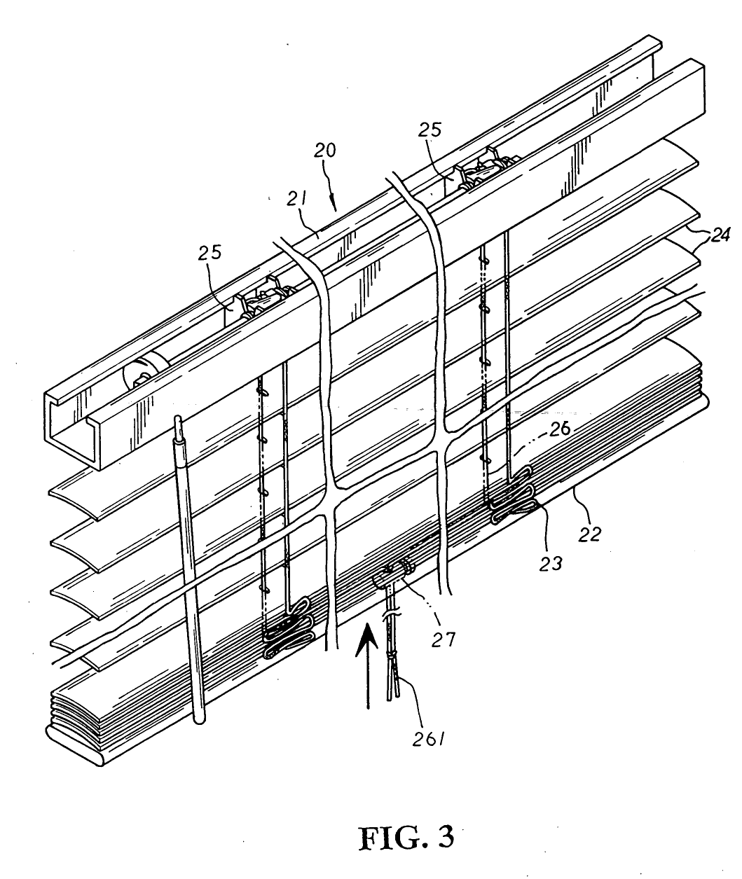

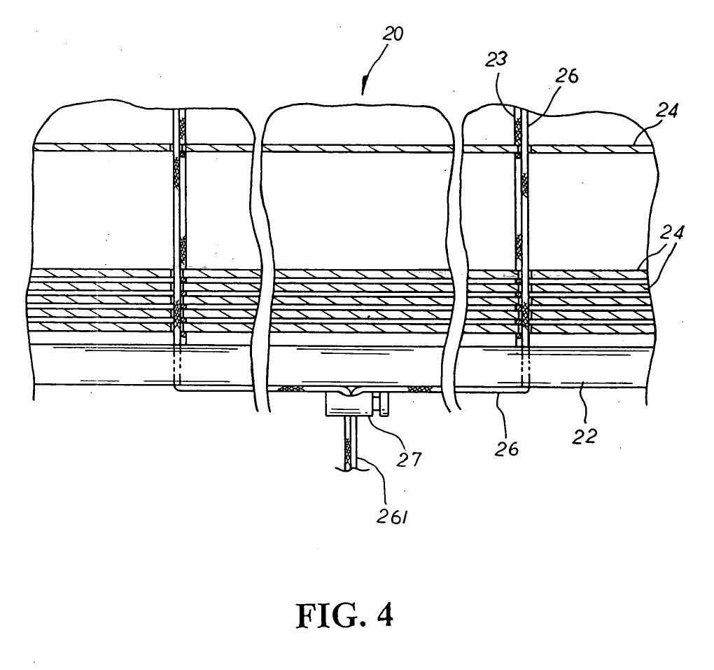

Please refer to FIGS. 2 to 4 inclusive. The present invention is related to a blind slat structure, including a Venetian blind 20 made up of rope ladders 23 mounted between an upper and lower beams 21, 22 for a plurality of slats 24 to be sequentially led there-through and equidistantly abutted against for location thereby. The upper ends of the rope ladders 23 are wound through and located at mounting seats 25, each having an adjustment roller, which are adapted at both inner lateral sides of the upper beam 21 therein to control the rotation of the slats 24 in different angles thereby. A guide cord 26 fixed inside the upper beam 21 at preset position relative to the two mounting seats 25 thereof is extended downwards by the ends to sequentially pass through cord-passages holes 241 disposed at the left/right sides of each slat 24 thereof from top to bottom till coming out through the lower beam 22 thereof. Both ends of the guide cord 26 are correspondingly stretched inwards to the middle section at the bottom side of the lower beam 22 and collected together by a retaining body 27 with a pulling section 261 suspending downwards for a certain length there-from. A clamping button 271 is mounted inside the retaining body 27 and protruding outwards there-from at one side thereof. In operation, the clamping button 271 thereof is pushed to detach the guide cord 26 from the clamping location of the retaining body 27 thereby. Then, the pulling section 261 thereof is evenly drawn downwards to lift upwards the retaining body 27 along the guide cord 26 thereof, synchronically pushing at the lower beam 22 to move upwards therewith as shown in FIG. 3. When the slats 24 are sequentially piled up from bottom to top to a desirable position in the adjustment thereof, the push button 271 is released to clamp tight the guide cord 26 held at the retaining body 27 therein for relocation thereby as shown in FIG. 4. And to unfold the piled-up slats 24 of the Venetian blind 20 thereof, the push button 271 of the retaining body 27 is pressed for the retaining body 27 to move downwards, permitting the lower beam 22 carried by its own weight to slide smoothly downwards along the guide cord 26 therewith. Thus, the Venetian blind 20 is simply operated with ease and less effort and economically structured without any pulley seats and pull cords of the conventional Venetian blind applied thereto, efficiently saving the cost of materials as well as maintaining a smooth and neat appearance of the upper beam 21 so as to boost the competitive power thereof on the market.

1. A blind slat structure, including a Venetian blind made up of rope ladders mounted between an upper and lower beams for a plurality of slats to be sequentially led there-through and equidistantly abutted against for location thereby wherein the upper ends of the rope ladders are wound through and located at mounting seats adapted at both inner lateral sides of the upper beam to control the rotation of the slats in different angles thereby, and a guide cord, fixed inside the upper beam at preset position relative to the mounting seats thereof, is extended downwards by the ends to sequentially pass through cord-passages holes disposed at the left/right sides of each slat thereof till both ends thereof coming out through the lower beam and correspondingly stretched inwards to the middle section at the bottom side of the lower beam to be collected together by a retaining body with a pulling section suspending downwards for a certain length there-from; in operation, the slats of the Venetian blind thereof is simply collected or unfolded via the retaining body that, directly abutted against the lower beam, is easily slid upwards or downwards along the guide cords with the lower beam synchronically moved up or down therewith, achieving an easy and effortless operation thereof so as to avoid the uncomfortable feeling of abrasion to hands caused by a conventional Venetian blind, and efficiently protecting the hands of a user as well as facilitating a smoother and easer operation thereof.
